(19) United States
(12) Patent Application Publication
(10) Pub. No.: US 2026/0307519 A1
(43) Pub. Date: Oct. 8, 2026

(54) CHARGING STATION POWERED BY A RENEWABLE ENERGY SOURCE

(71) Applicant: Sage Geosystems Inc., Houston, TX (US)

(72) Inventors: Brianna L. BYRD, Houston, TX (US); Nathan WEISS, Bellaire, TX (US); Robert Lance COOK, Houston, TX (US)

(21) Appl. No.: 19/483,160

(22) PCT Filed: May 22, 2024
(86) PCT No.: PCT/US2024/030535

§ 371 Date: Nov. 10, 2025

Related U.S. Application Data
(60) Provisional application No. 63/504,640, filed on May 26, 2023.

(51) Int. Cl. B60L 53/50; B60L 53/12; B60L 53/14; B60L 53/302; B60L 53/51; B60L 53/52; B60L 53/62; H01M 10/42; H01M 10/44; H01M 10/48; H01M 10/615; H01M 10/625; H01M 10/656

(52) U.S. Cl. CPC B60L 53/50; B60L 53/12; B60L 53/14; B60L 53/302; B60L 53/51; B60L 53/52; B60L 53/62; H01M 10/425; H01M 10/443; H01M 10/486; H01M 10/615; H01M 10/625; H01M 10/656; B60L 2240/545; B60L 2240/547; H01M 2220/20

(57) ABSTRACT

An electrical vehicle charging system includes a geothermal power generation system configured to convert geothermal heat and/or pressure energy to direct current electrical power. A charging station is electrically coupled to the geothermal power system, and receives the direct current electrical power The charging station is configured to couple to a battery of an electrical vehicle and provide a direct current to the battery. The electrical vehicle charging system may also include a controller configured to implement a plurality of computer executable instructions that, when implemented by the controller, cause the electrical vehicle charging system to charge an electrical vehicle.

### CROSS-REFERENCE TO RELATED APPLICATIONS

This application is an International Patent Application under the Patent Cooperation Treaty and claims priority to and the benefit of U.S. Provisional Patent Application Ser. No. 63/504,640 filed May 26, 2023, titled Geothermal Powered Charging Station, the disclosure of which is incorporated herein in its entirety by this reference.

### BACKGROUND

### Field

Embodiments of the present disclosure generally relate to electrical power charging systems and utilities (such as publically-accessible stations) for charging electric vehicles of any type.

### Description of the Related Art

Some forecasts predict an exponential growth in the number of electric vehicles being used in the short to medium term. For example, one study by PwC estimates the number of electric vehicles in operation in the United States to reach 27 million by 2030 and 92 million by 2040.

In January 2024, the United States government announced a package of federal grants aimed towards establishing 500,000 publically-accessible electric vehicle charging points across the United States by 2030. Such a rapid increase in electric vehicle charging points will place ever-increasing demands on existing electrical power generation capacity and on existing electrical power distribution grids. The construction of such infrastructure is expensive and time consuming. Furthermore, some charging points will necessarily be located in more remote areas away from electrical power generation plants and existing electrical power distribution grids.

There is a need for improved systems and processes that facilitate the charging of electric vehicles without overloading existing electrical power infrastructure. There is a further need for improved systems and processes that facilitate the charging of electric vehicles in remote areas.

### SUMMARY

The present disclosure generally relates to electrical power charging systems and utilities (such as publically-accessible stations) for charging electric vehicles of any type. In one implementation, a system includes a geothermal power plant configured to produce direct current electrical power. The system further includes a charging station that is electrically coupled to the geothermal power plant, and is configured to receive the direct current electrical power and provide a direct current to a battery of an electric or hybrid vehicle.

In another implementation, a system includes a power plant configured to produce direct current electrical power, and a charging station electrically coupled to the power plant. The charging station is configured to receive the direct current electrical power and provide a direct current to a battery of an electric or hybrid vehicle. The system further includes a controller comprising instructions that, when executed, cause a plurality of operations to be conducted. The plurality of operations include detecting that the charging station is coupled to a battery of an electric or hybrid vehicle, detecting a voltage of the battery, determining a magnitude of the direct current at which the charging station charges the battery as a function of the voltage of the battery, and supplying the direct current to the battery.

In another implementation, a method of charging a battery of an electric or hybrid vehicle at a charging station includes receiving, at the charging station, direct current electrical power from a power plant, detecting that the charging station is coupled to the battery, detecting a voltage of the battery, determining a magnitude of a direct current at which the charging station charges the battery as a function of the voltage of the battery, and supplying the direct current to the battery.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 schematically illustrates a geothermal power plant.

FIG. 2 schematically illustrates an electric vehicle charging station.

FIG. 3 schematically illustrates a local power distribution system.

FIG. 4 schematically illustrates a system for charging a battery.

FIG. 5 schematically illustrates a system for charging a battery.

FIG. 6 is a flow diagram of a method of charging a battery.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns electrical power charging systems and utilities (such as publically-accessible stations) for charging electric vehicles of any type. The electric vehicles include vehicles that are powered for motion by one or more electric motors. The electric vehicles include hybrid vehicles that are powered for motion by one or more electric motors and by an internal combustion engine.

In some aspects, features of the present disclosure facilitate the siting of electric vehicle charging systems or stations in locations where there is no (or limited) existing electrical transportation infrastructure or capacity, such as in remote and/or rural areas. Such developments enhance the utility and attractiveness of electric vehicles for applications (such as long distance travel) for which only vehicles with internal combustion engines have been considered to be suitable.

Recent improvements in geothermal power systems allow their use not only in areas that are recognized sources of geothermal power, but also in areas previously thought to be unsuitable for producing electricity by geothermal systems. In addition, co-locating an electric vehicle charging system or station with a power system, such as a solar, solar thermal, wind-driven, or geothermal power system, could reduce or even eliminate the costs (infrastructure, transmission losses, etc.) involved with transmitting electricity over distances of several kilometers (such as tens of kilometers) compared with the provision of a conventional electrical power grid.

Co-locating an electric vehicle charging system or station with a power system, such as a solar, solar thermal, wind-driven, or geothermal power system, facilitates the generation of direct current (DC) electrical power by the power system and transmitting the DC power to the electric vehicle charging system or station. Electric vehicle charging systems that utilize a DC power input currently can operate at 350 to 500 kW, and typically charge batteries relatively quickly. In contrast, electric vehicle charging systems that utilize an alternating current (AC) electrical power input typically are limited to approximately 40 to 100 kW of power, and charge batteries relatively slowly.

The more rapid charging provided by DC systems is more desirable at charging stations located beside major highways or remote from other facilities. For example, such rapid charging would be particularly desirable at locations where common driver behavior would be to spend an hour or less, such as at a temporary stop during a road journey.

Additionally, the generation and transmission of DC power local to an electric vehicle charging station may reduce or eliminate the infrastructure and costs associated with the generation and transmission of AC electrical power and the conversion of the AC electrical power to DC electrical power.

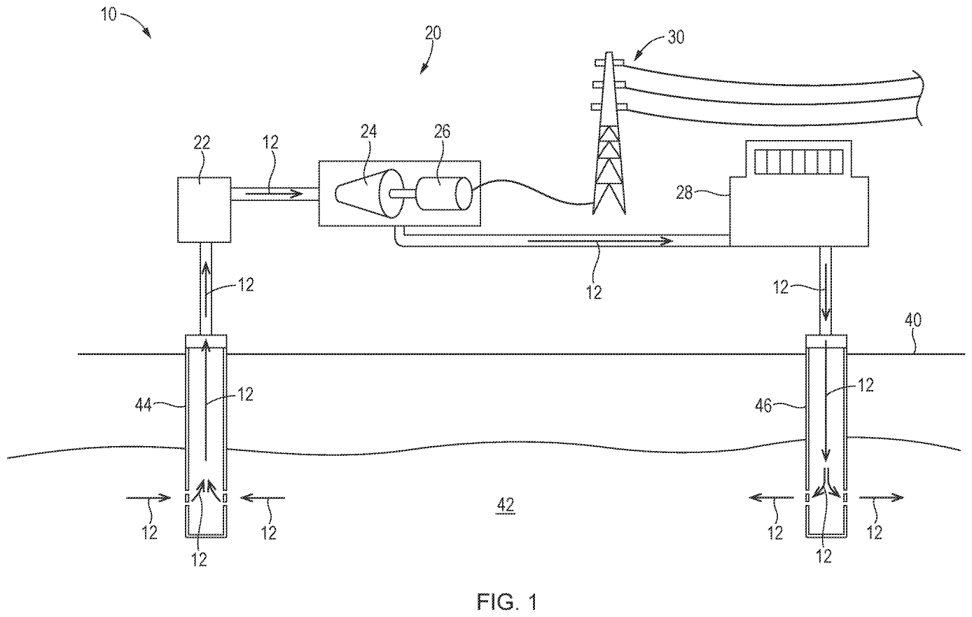

FIG. 1 schematically illustrates a geothermal power plant 10. The geothermal power plant 10 includes a power generation unit 20 located at the Earth's surface 40. The power generation unit 20 may be of any suitable type that converts heat energy and/or pressure energy to electricity, and may include any one or more of an expansion unit 22, a turbine 24, a generator 26, or a cooling unit 28. Some examples of representative power generation units 20 include a direct dry steam plant, a flash plant, a binary plant, a combined-cycle or hybrid plant, etc., that receives heated fluid from surface or subsurface sources of heat. In an example, the turbine 24 drives the generator 26 to produce electricity. In some embodiments, the generator 26 produces DC electrical power. In some embodiments, the generator 26 produces AC electrical power.

The geothermal power plant 10 utilizes a working fluid (represented by arrows 12), such as water, steam, brine, a refrigerant, a supercritical fluid, carbon dioxide, ammonia, an organic compound (e.g., a hydrocarbon, a fluorocarbon, etc.), or any combination thereof. In some embodiments, the working fluid 12 is heated, or is maintained at an elevated temperature, in a subterranean formation 42. In an example, the temperature of the working fluid 12 is at or about 150 degrees C or higher, such as 175 degrees C or higher, 200 degrees C or higher, 250 degrees C or higher, or 300 degrees C or higher.

In some embodiments, the working fluid 12 is maintained at an elevated pressure in the subterranean formation 42. In an example, the pressure of the working fluid 12 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the working fluid 12 is geopressured. In an example, the working fluid 12 may be a geopressured-geothermal fluid.

The working fluid 12 flows from the subterranean formation 42 to surface 40 via a first well 44. The first well 44 is a geothermal well. The working fluid 12 is utilized by the geothermal power plant 10 to produce electricity. In some embodiments, the working fluid 12 powers the turbine 24 which drives the generator 26. In some embodiments, the power generation unit 20 transfers heat energy and/or pressure energy of the working fluid 12 to a second fluid, and the second fluid powers the turbine 24 which drives the generator 26. In some embodiments, the generator 26 produces AC electrical power. In some embodiments, the generator 26 produces DC electrical power. The generated electricity is routed to an electricity distribution system 30, such as a power grid. In the illustrated example, the working fluid 12 is returned to the subterranean formation 42 via a second well 46. In some embodiments, the working fluid 12 is returned to the subterranean formation 42 via the first well 44.

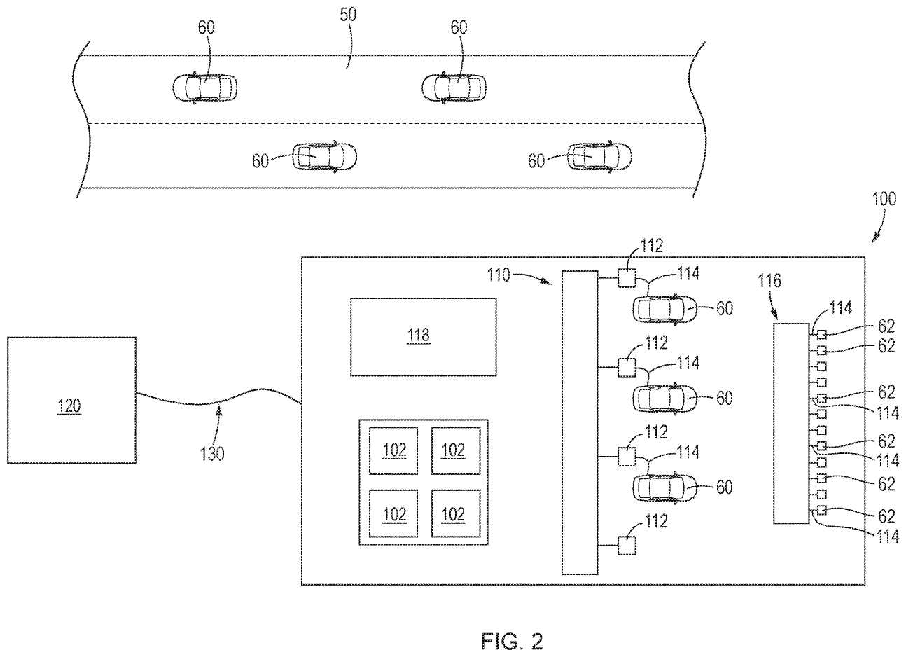

FIG. 2 schematically illustrates a charging station 100. The charging station 100 is shown located beside, or close to, a highway 50. Vehicles 60 depicted traveling along the highway 50 and situated at the charging station 100 include electric vehicles or hybrid vehicles. The vehicles 60 include cars, motorcycles, trucks, vans, goods transportation vehicles, buses, etc. The charging station 100 is configured to charge electric vehicles and/or hybrid vehicles. In an example, the charging station 100 is configured to charge one or more batteries of an electric vehicle or a hybrid vehicle. Each of the one or more batteries is a traction battery configured to power an electric traction motor that drives the wheels of the corresponding electric vehicle or hybrid vehicle.

In some embodiments, the charging station 100 includes one or more vehicle charging facilities 110 that include one or more charging points 112. As shown, each charging point 112 may be coupled to a corresponding vehicle 60 by a charging cable 114. One or more battery of a vehicle 60 may be charged at a charging point 112 while the vehicle 60 is coupled to the charging point 112. In some embodiments, the one or more vehicle charging facilities 110 use AC power only. In some embodiments, the one or more vehicle charging facilities 110 use DC power only. In some embodiments, the one or more vehicle charging facilities 110 use AC power and DC power.

In some embodiments, the charging station 100 includes one or more charging amenities 116 for batteries 62 that are not installed in a vehicle 60. Each battery 62 is a traction battery configured to power an electric traction motor that drives the wheels of a corresponding electric vehicle or hybrid vehicle. In an example, a battery 62 held in storage is charged at a charging amenity 116 of the charging station 100, and then is installed in a vehicle 60 to replace a drained or damaged battery of the vehicle 60. The battery 62 is coupled to the charging amenity 116 by a charging cable 114. In some embodiments, the one or more charging amenities 116 use AC power only. In some embodiments, the one or more charging amenities 116 use DC power only. In some embodiments, the one or more charging amenities 116 use AC power and DC power.

In some embodiments, the charging station 100 includes equipment 118 that uses AC power. In an example, the equipment 118 includes lighting, one or more refrigerators or freezers, communication equipment (such as internet, cable, satellite, or telephone equipment), or other AC electrical items, such as AC electrical items that are typically used in a convenience store or restaurant.

The charging station 100 receives electrical power from a power plant 120. In some embodiments, the charging station 100 includes one or more station batteries 102 that store DC power for use at the charging station 100. The one or more station batteries 102 are charged by the electricity received from the power plant 120. As described below, the one or more station batteries 102 supply electrical power to the one or more vehicle charging facilities 110, the one or more charging amenities 116, or the equipment 118 that uses AC power.

In some embodiments, the power plant 120 includes a solar power plant. In some embodiments, the power plant 120 includes a solar thermal power plant. In some embodiments, the power plant 120 includes a wind-driven power plant. In some embodiments, the power plant 120 includes a geothermal power plant, such as geothermal power plant 10.

In some embodiments, the power plant 120 includes a first power plant and a second power plant. The first power plant is one of a solar power plant, a solar thermal power plant, a wind-driven power plant, or a geothermal power plant (such as geothermal power plant 10). The second power plant is a different one of a solar power plant, a solar thermal power plant, a wind-driven power plant, or a geothermal power plant (such as geothermal power plant 10). In an example, the power plant 120 includes a solar power plant and a geothermal power plant (such as geothermal power plant 10). In another example, the power plant 120 includes a solar thermal power plant and a geothermal power plant (such as geothermal power plant 10). In a further example, the power plant 120 includes a wind-driven power plant and a geothermal power plant (such as geothermal power plant 10).

In some embodiments, the power plant 120 generates AC electrical power only. In some embodiments, the power plant 120 generates DC electrical power only. In some embodiments, the power plant 120 generates AC electrical power and DC electrical power. In an example, at least one generator (such as generator 26) generates AC electrical power, and at least one generator (such as another generator 26) generates DC electrical power.

The electricity generated by the power plant 120 is transmitted to the charging station 100 by a local power distribution system 130, such as the electricity distribution system 30. In some embodiments, the local power distribution system 130 transmits AC power only to the charging station 100. In some embodiments, the local power distribution system 130 transmits DC power only to the charging station 100. In some embodiments, the local power distribution system 130 transmits AC power and DC power to the charging station 100.

In some embodiments, at least a portion of the power plant 120 (such as first well 44 of geothermal power plant 10) is co-located with the charging station 100. In an example, at least a portion of the power plant 120 is located close to the charging station 100, such as up to 5 km, up to 4 km, up to 3 km, up to 2 km, or up to 1 km from the charging station 100. In another example, at least a portion of the power plant 120 is located at a distance from the charging station 100 such that the efficiencies of transmitting a direct current from the power plant 120 to the charging station 100 are greater than the efficiencies of converting the direct current to alternating current at the power plant 120, and then converting the alternating current back to direct current at the charging station 100. In another example, at least a portion of the power plant 120 is located at a distance from the charging station 100 such that the portion of the power plant 120 is located within a square mile (2.6 sq. km) of the charging station 100, such as within a half square mile (1.3 sq. km), within a quarter square mile (0.65 sq. km), within a tenth of a square mile (0.26 sq. km), within a hundredth of a square mile (0.026 sq. km), or within a thousandth of a square mile (0.0026 sq. km) of the charging station 100.

In some embodiments, the local power distribution system 130 is electrically coupled to a national or regional power distribution system. In some embodiments, the local power distribution system 130 is an autonomous power distribution system that is not electrically coupled with a national or regional power distribution system. In some embodiments, the charging station 100 is electrically coupled to a national or regional power distribution system in addition to being electrically coupled to the local power distribution system 130. In some embodiments, the charging station 100 is not electrically coupled to a national or regional power distribution system, but is electrically coupled to the local power distribution system 130.

In some embodiments, the charging station 100 receives at least a portion of the electrical power used on site via a national or regional power distribution system. In some embodiments, the charging station 100 does not receive any electrical power via a national or regional power distribution system. In some embodiments, the charging station 100 receives at least 50% (such as at least 60%, at least 70%, at least 80%, or at least 90%) of the electrical power used on site via the local power distribution system 130. In some embodiments, the charging station 100 receives 100% of the electrical power used on site via the local power distribution system 130.

In some embodiments, the charging station 100 receives at least a portion of the electrical power used on site from the power plant 120. In some embodiments, the charging station 100 receives at least 50% (such as at least 60%, at least 70%, at least 80%, or at least 90%) of the electrical power used on site from the power plant 120. In some embodiments, the charging station 100 receives 100% of the electrical power used on site from the power plant 120.

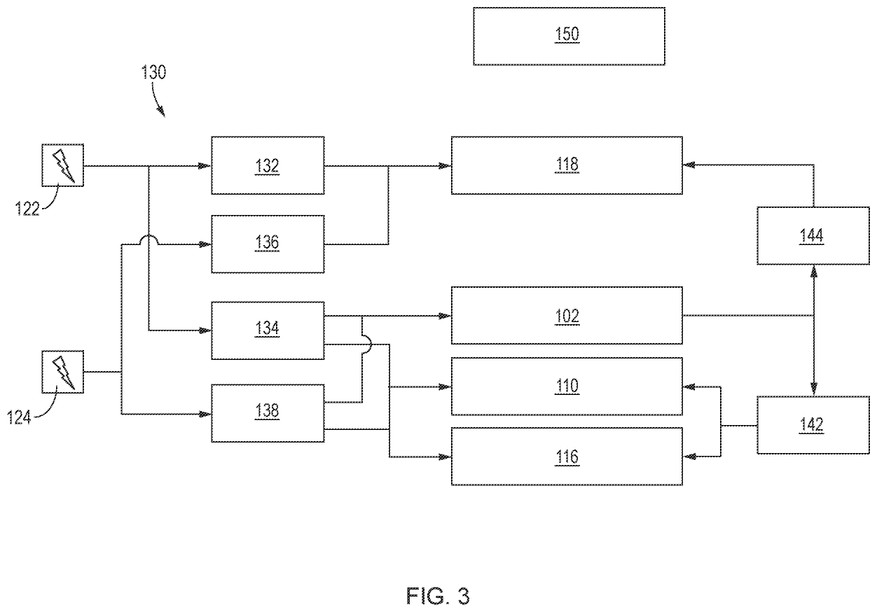

FIG. 3 schematically illustrates the local power distribution system 130 in further detail. The local power distribution system 130 is illustrated to represent embodiments in which the local power distribution system 130 receives AC power from an AC power supply 122 (such as the power plant 120 or a national or regional power distribution system). The local power distribution system 130 is illustrated also to represent embodiments in which the local power distribution system 130 receives DC power from a DC power supply 124 (such as the power plant 120 or a national or regional power distribution system).

In some embodiments, the local power distribution system 130 is electrically coupled to the AC power supply 122 but not to the DC power supply 124. In some embodiments, the DC power supply 124 is omitted. In some embodiments, the local power distribution system 130 is electrically coupled to the DC power supply 124 but not to the AC power supply 122. In some embodiments, the AC power supply 122 is omitted. In some embodiments, the local power distribution system 130 is electrically coupled to the AC power supply 122 and to the DC power supply 124.

In some embodiments, at least a portion of the local power distribution system 130 is operated as a DC microgrid. In some embodiments, such as embodiments in which the AC power supply 122 is omitted, the entire local power distribution system 130 is operated as a DC microgrid. A DC microgrid has several advantages over an AC power distribution system. DC microgrids can be integrated easily with the power plant 120 in embodiments in which the power plant 120 includes one or more renewable energy sources, such as solar, solar thermal, wind, or geothermal energy sources. The DC microgrid may include fewer or smaller stages of power conversion compared to an AC power distribution system. A DC system has no skin effect resulting from induced changing currents in a conductor core. The lack of skin effect reduces losses to power transmission, and permits the use of fewer conductors. Some features of an AC power distribution system, such as grid synchronization, harmonics compensation, and reactive power control, typically are not required for DC-based systems. A DC microgrid provides continuous power supply to an electrical load during power outages and grid disturbances by using electrical storage systems (e.g. battery backups), such as the station batteries 102. A DC microgrid typically requires only one component/factor to control, i.e., DC power.

In some embodiments in which the local power distribution system 130 receives AC power from the AC power supply 122, at least a portion of the AC power is routed via one or more transformers 130 to the equipment 118 that uses AC power. At least a portion of the AC power is routed to one or more AC-to-DC converters 134. The one or more AC-to-DC converters 134 convert the AC power to DC power. The one or more AC-to-DC converters 134 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, the DC power produced by the one or more AC-to-DC converters 134 is routed to the station batteries 102 for charging the station batteries 102. In some embodiments, the DC power produced by the one or more AC-to-DC converters 134 is routed to the one or more vehicle charging facilities 110 for charging the batteries installed in electric or hybrid vehicles 60. In some embodiments, the DC power produced by the one or more AC-to-DC converters 134 is routed to the one or more charging amenities 116 for charging the batteries 62 that are not installed in electric or hybrid vehicles 60.

In some embodiments, the one or more AC-to-DC converters 134 include a first AC-to-DC converter 134 configured to produce DC power at a first voltage, and a second AC-to-DC converter 134 configured to produce DC power at a second voltage that is different from the first voltage. In an example, the first voltage may be suitable for charging the station batteries 102 (such as 12V, 24 V, or 48 V), and the second voltage may be suitable for charging electric or hybrid vehicle batteries 62 (such as 480 V to 1 kV). In some embodiments, the DC power from the one or more AC-to-DC converters 134 is routed to a DC-to-DC converter to produce DC power at an appropriate voltage prior to routing the DC power to the station batteries 102, the one or more vehicle charging facilities 110, or the one or more charging amenities 116.

In some embodiments in which the local power distribution system 130 receives DC power from the DC power supply 124, at least a portion of the DC power is routed via one or more DC-to-AC inverters 136 to the equipment 118 that uses AC power. The one or more DC-to-AC inverters 136 convert the DC power to AC power. The one or more DC-to-AC inverters 136 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, at least a portion of the DC power is routed via one or more DC-to-DC converters 138 to the station batteries 102 for charging the station batteries 102. In some embodiments, at least a portion of the DC power is routed via the one or more DC-to-DC converters 138 to the one or more vehicle charging facilities 110 for charging the batteries installed in electric or hybrid vehicles 60. In some embodiments, at least a portion of the DC power is routed via the one or more DC-to-DC converters 138 to the one or more charging amenities 116 for charging the batteries 62 that are not installed in electric or hybrid vehicles 60.

The one or more DC-to-DC converters 138 facilitate smoothing of the current and voltage received from the DC power supply 124, and output DC power at appropriate voltage and current for use. The one or more DC-to-DC converters 138 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, the one or more DC-to-DC converters 138 include a first DC-to-DC converter 138 configured to produce DC power at a first voltage, and a second DC-to-DC converter 138 configured to produce DC power at a second voltage that is different from the first voltage. In an example, the first voltage may be suitable for charging the station batteries 102 (such as 12V, 24 V, or 48 V), and the second voltage may be suitable for charging electric or hybrid vehicle batteries 62 (such as 480 V to 1 kV).

In some embodiments, at least a portion of the DC power is routed to the station batteries 102 without being transmitted via the one or more DC-to-DC converters 138. In some embodiments, at least a portion of the DC power is routed to the one or more vehicle charging facilities 110 without being transmitted via the one or more DC-to-DC converters 138. In some embodiments, at least a portion of the DC power is routed to the one or more charaina amenities 116 without being transmitted via the one or more DC-to-DC converters 138. In some embodiments, the one or more DC-to-DC converters 138 may be bypassed or omitted.

In some embodiments, the station batteries 102 provide back-up power to the charging station 100. In an example, the station batteries 102 provide back-up power to the one or more vehicle charging facilities 110 for charging the batteries (such as the batteries 62) installed in electric or hybrid vehicles 60. In another example, the station batteries 102 provide back-up power to the one or more charging amenities 116 for charging the batteries 62 that are not installed in electric or hybrid vehicles 60. DC power provided by the station batteries 102 is routed via one or more DC-to-DC converters 142 to the one or more vehicle charging facilities 110 or to the one or more charging amenities 116. The one or more DC-to-DC converters 142 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination. In some embodiments, the one or more DC-to-DC converters 142 may be bypassed or omitted.

In some embodiments, the station batteries 102 provide back-up power to the equipment 118 that uses AC power. DC power provided by the station batteries 102 is routed via one or more DC-to-AC inverters 144 to the equipment 118 that uses AC power. The one or more DC-to-AC inverters 144 convert the DC power from the station batteries 102 into AC power for the equipment 118. The one or more DC-to-AC inverters 144 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, operation of the charging station 100 or the local power distribution system 130 is controlled at least in part by a controller 150. The controller 150 includes a central processing unit (CPU), a memory containing instructions, and support circuits for the CPU. The memory, or non-transitory computer readable medium, is one or more of a readily available memory such as random access memory (RAM), read only memory (ROM), floppy disk, hard disk, flash drive, solid state drive, or any other form of digital storage, local or remote. The support circuits are coupled to the CPU for supporting the CPU. The support circuits include cache, power supplies, clock circuits, input/output circuitry and subsystems, and the like. Operations and operating parameters are stored in the memory as a software routine that is executed or invoked to configure the controller 150 into a specific purpose controller to control the operations of the charging station 100 or the local power distribution system 130. The controller 150 is configured to conduct one or more of the operations described herein. The instructions stored on the memory, when executed, cause one or more of the operations described herein to be conducted.

In some embodiments, the controller 150 is communicatively coupled to the one or more vehicle charging facilities 110. In some of such embodiments, the controller 150 is communicatively coupled to each charging point 112 of the one or more vehicle charging facilities 110. In an example, the controller 150 is communicatively coupled to one or more sensors of the one or more vehicle charging facilities 110, such as one or more sensors of each charging point 112. The controller 150 monitors and controls the functioning of the one or more vehicle charging facilities 110.

In some embodiments, the controller 150 is communicatively coupled to the one or more charging amenities 116 for charging batteries 62 that are not installed in electric or hybrid vehicles 60. In an example, the controller 150 is communicatively coupled to one or more sensors of the one or more charging amenities 116. The controller 150 monitors and controls the functioning of the one or more charging amenities 116.

In some embodiments, the controller 150 is communicatively coupled to each station battery 102. In an example, the controller 150 is communicatively coupled to one or more sensors of each station battery 102. The controller 150 monitors and controls the functioning of each station battery 102.

In some embodiments, the controller 150 is communicatively coupled to one or more items of the equipment 118 that use AC power. In an example, the controller 150 is communicatively coupled to one or more sensors of the one or more items of the equipment 118. The controller 150 monitors and controls the functioning of the one or more items of the equipment 118.

In some embodiments, the controller 150 is communicatively coupled to the local power distribution system 130. In an example, the controller 150 is communicatively coupled to one or more sensors of the local power distribution system 130. The controller 150 monitors and controls the functioning of the one or more items of the local power distribution system 130.

In some embodiments, the controller 150 is communicatively coupled to the one or more transformers 132. In an example, the controller 150 is communicatively coupled to one or more sensors of the one or more transformers 132. The controller 150 monitors and controls the functioning of the one or more transformers 132.

In some embodiments, the controller 150 is communicatively coupled to the one or more AC-DC converters 134. In an example, the controller 150 is communicatively coupled to one or more sensors of the one or more AC-DC converters 134. The controller 150 monitors and controls the functioning of the one or more AC-DC converters 134.

In some embodiments, the controller 150 is communicatively coupled to the one or more DC-AC inverters 136. In an example, the controller 150 is communicatively coupled to one or more sensors of the one or more DC-AC inverters 136. The controller 150 monitors and controls the functioning of the one or more DC-AC inverters 136.

In some embodiments, the controller 150 is communicatively coupled to the one or more DC-DC converters 138. In an example, the controller 150 is communicatively coupled to one or more sensors of the one or more DC-DC converters 138. The controller 150 monitors and controls the functioning of the one or more DC-DC converters 138.

In some embodiments, the controller 150 is communicatively coupled to the one or more DC-DC converters 142. In an example, the controller 150 is communicatively coupled to one or more sensors of the one or more DC-DC converters 142. The controller 150 monitors and controls the functioning of the one or more DC-DC converters 142.

In some embodiments, the controller 150 is communicatively coupled to the one or more DC-AC inverters 144. In an example, the controller 150 is communicatively coupled to one or more sensors of the one or more DC-AC inverters 144. The controller 150 monitors and controls the functioning of the one or more DC-AC inverters 144.

In some embodiments, the controller 150 is communicatively coupled to the power plant 120. In an example, the controller 150 is communicatively coupled to one or more sensors of the power plant 120. The controller 150 monitors and controls the functioning of the power plant 120.

In some embodiments, the controller 150 is communicatively coupled to the AC power supply 122. In an example, the controller 150 is communicatively coupled to one or more sensors of the AC power supply 122. The controller 150 monitors and controls the functioning of the AC power supply 122.

In some embodiments, the controller 150 is communicatively coupled to the DC power supply 124. In an example, the controller 150 is communicatively coupled to one or more sensors of the DC power supply 124. The controller 150 monitors and controls the functioning of the DC power supply 124.

In some embodiments, the charging station 100 or the local power distribution system 130 may include one or more communications network interfaces suitable for communicating information with other computers and electronic devices, including (for example) a central service, such as a cloud service, from which the charging station 100 receives information including trained machine learning models and other data for use in autonomous control thereof. The one or more communications networks, for example, may include a wide area network (“WAN”) such as the Internet, one or more local area networks (“LANs”) such as Wi-Fi LANs, mesh networks, etc., or one or more bus subsystems. In some embodiments, the one or more communications networks utilize one or more standard communication technologies, protocols, and/or inter-process communication techniques. In some implementations, data collected by one or more sensors (such as described herein) can be uploaded to a remote data center, that may include a processor, via the one or more communications networks for additional processing.

The controller 150, as well as various additional controllers, processors, or subsystems such as disclosed herein, operates under the control of an operating system and executes or otherwise relies upon various computer software applications, components, programs, objects, modules, data structures, etc. Moreover, various applications, components, programs, objects, modules, etc. may also execute on one or more processors in another computer coupled to the charging station 100 via the one or more communications networks, e.g., in a distributed, cloud-based, or client-server computing environment, whereby the processing required to implement the functions of a computer program may be allocated to multiple computers and/or services over a computer network.

In general, the routines executed to implement the various implementations described herein, whether implemented as part of an operating system or a specific application, component, program, object, module, or sequence of instructions, or even a subset thereof, may be referred to herein as “program code.” Program code typically includes one or more instructions that are resident at various times in various memory and storage devices, and that, when read and executed by one or more processors, perform actions necessary to execute operations embodying the various aspects of the present disclosure. Furthermore, while implementations are described herein in the context of fully functioning computers and systems, it will be appreciated that the various implementations described herein are capable of being distributed as a program product in a variety of forms, and that implementations can be implemented regardless of the particular type of computer readable media used to actually carry out the distribution.

In addition, one or more program codes described herein may be identified based upon the application within which a particular program code is implemented in a specific implementation. However, it should be appreciated that any particular program nomenclature herein is used merely for convenience, and thus the present disclosure should not be limited to use solely in any specific application identified and/or implied by such nomenclature. Furthermore, given the typically endless number of manners in which computer programs may be organized into routines, procedures, methods, modules, objects, or the like, as well as the various manners in which program functionality may be allocated among various software layers that are resident within a typical computer (e.g., operating systems, libraries, API's, applications, applets, etc.), it should be appreciated that the present disclosure is not limited to the specific organization and allocation of program functionality described herein.

The example environment illustrated is not intended to limit implementations disclosed herein. Indeed, other alternative hardware and/or software environments may be used without departing from the scope of implementations disclosed herein.

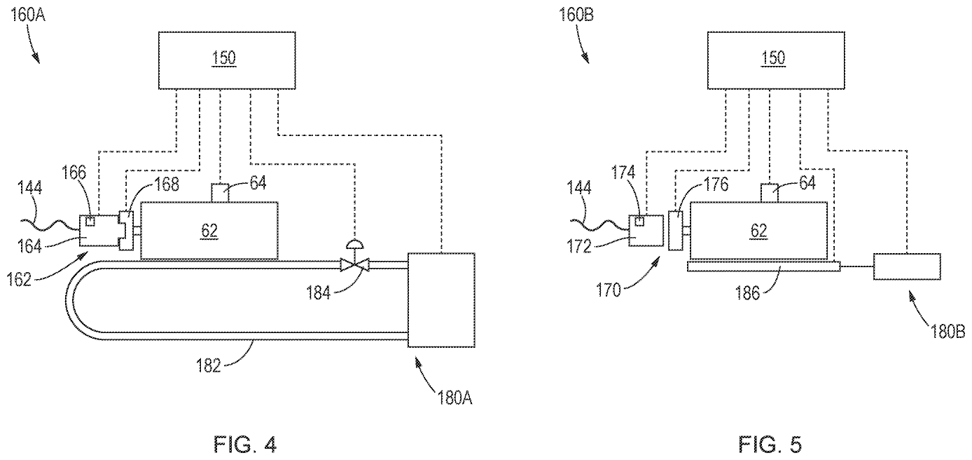

FIG. 4 schematically illustrates a system 160A for charging a battery 62. In some embodiments, the battery 62 is installed in a vehicle, such as vehicle 60. In some embodiments, the battery 62 is not installed in a vehicle. The battery 62 is charged by applying a charging voltage to the battery 62 via a wired electrical connection 162.

The wired electrical connection 162 includes an adapter 164 (coupled to charging cable 114) plugged into a receptacle 168 that is electrically coupled to the battery 62. In some embodiments, the receptacle 168 is integral with the battery 62. In some embodiments, the receptacle 168 is not integral with the battery 62. In some embodiments, the receptacle 168 is at least part of a charging port of the vehicle 60 in which the battery 62 is installed. In some embodiments, the adapter 164 is part of a charging point 112 of the one or more vehicle charging facilities 110 at the charging station 100. In some embodiments, the adapter 164 is part of the charging amenity 116 for charging batteries 62 that are not installed in a vehicle. In some embodiments, AC power is applied via the adapter 164 to the receptacle 168, and an AC-to-DC converter converts the AC power into DC power, which is applied to the battery 62. In some embodiments, DC power is applied to the battery 62 via the adapter 164 and the receptacle 168.

In some embodiments, the controller 150 is communicatively coupled to the adapter 164. For example, the controller 150 may be communicatively coupled to one or more sensors 166 of the adapter 164. In some embodiments, one of the one or more sensors 166 measures a parameter of the adapter 164 or of the battery 62, such as a voltage of the battery 62, a voltage or current at the adapter 164, or a temperature of the adapter 164. The controller 150 monitors and controls the functioning of the adapter 164.

In some embodiments, the controller 150 is communicatively coupled to the receptacle 168. In an example, the controller 150 is communicatively coupled to one or more sensors of the receptacle 168. In some embodiments, the one or more sensors 166 are installed in the receptacle 168 instead of in the adapter 164. In some embodiments, at least one sensor 166 is installed in the receptacle 168 and at least one sensor 166 is installed in the adapter 164. In some embodiments, the controller 150 monitors and controls the functioning of the receptacle 168.

In some embodiments, the controller 150 is communicatively coupled to the battery 62. In an example, the controller 150 is communicatively coupled to one or more sensors 64 of the battery 62. In some embodiments, the one or more sensors measures a parameter of the battery 62, such as a voltage of the battery 62, a current being supplied to the battery 62, or a temperature of the battery 62. In some embodiments, the controller 150 monitors and controls the charging of the battery 62.

In some embodiments, a thermal control module 180A facilitates adjustment of a temperature of the battery 62 prior to, during, or after charging the battery 62. In some embodiments, the thermal control module 180A provides heat to the battery 62. In some embodiments, the thermal control module 180A provides cooling to the battery 62.

As illustrated, in some embodiments, the thermal control module 180A includes a fluid circuit 182 that conveys one or more fluids to transfer heat to or from the battery 62. Exemplary fluids include gases (e.g. air), liquids, refrigerants, steam, brines, supercritical fluids (including supercritical carbon dioxide), mixed-phase fluids, working fluids (such as the working fluid 12), or the like. The fluid circuit 182 may include a heat exchanger, radiator, electrically resistive heater, thermoelectric heat pump or other integrated circuit heat pump, or other similar components.

In some embodiments, the fluid in the fluid circuit 182 is a fluid that is conveyed to the charging station 100 from the power plant 120 via a pipe or flow line. For example, the power plant 120 may include a geothermal power system (such as geothermal power plant 10), and the fluid in the fluid circuit 182 may be the working fluid 12 or a second fluid that is heated by the working fluid 12 in the geothermal power system.

In some embodiments, the controller 150 is communicatively coupled to the thermal control module 180A. In some embodiments, the controller 150 monitors and controls the functioning of the thermal control module 180A. In some embodiments, the controller 150 is communicatively coupled to the fluid circuit 182. For example, the controller 150 may be communicatively coupled to one or more sensors of the fluid circuit 182. In some embodiments, one of the one or more sensors measure a parameter of the fluid circuit 182, such as a flow rate of the fluid, a pressure of the fluid, or a temperature of the fluid. In some embodiments, the controller 150 monitors and controls the functioning of the fluid circuit 182.

In some embodiments, a flow of the fluid within the fluid circuit 182 is controlled by a valve 184. In some embodiments, the controller 150 is communicatively coupled to the valve 184. In some embodiments, the controller 150 monitors and controls the functioning of the valve 184.

It is contemplated that providing heat to the battery 62 while charging the battery 62 may improve the transfer of current to the battery 62. For example, a battery 62 that is heated to a temperature above an ambient temperature may charge faster than if the battery 62 is not heated to a temperature above an ambient temperature. Nevertheless, it is contemplated also that the battery 62 may require cooling during the charging if the temperature of the battery 62 approaches a predefined upper threshold. In some embodiments, the controller 150 monitors a temperature of the battery 62, and initiates the thermal control module 180A to provide heating or cooling to the battery 62 as needed.

FIG. 5 schematically illustrates a system 160B for charging a battery 62. In some embodiments, the battery 62 is installed in a vehicle, such as vehicle 60. In some embodiments, the battery 62 is not installed in a vehicle. The battery 62 is charged by applying a charging voltage to the battery 62 via an inductive connection 170.

The inductive connection 170 includes an inductive charging transmitter 172, shown coupled to charging cable 114. The inductive charging transmitter 172 includes a primary coil that wirelessly communicates with a secondary coil of an inductive charging receiver 176 that is electrically coupled to the battery 62. An electrical current passes through the primary coil and induces a current in the secondary coil.

In some embodiments, the inductive charging receiver 176 is integral with the battery 62. In some embodiments, the inductive charging receiver 176 is not integral with the battery 62. In some embodiments, the inductive charging receiver 176 is at least part of a charging port of the vehicle 60 in which the battery 62 is installed. In some embodiments, the inductive charging transmitter 172 is part of a charging point 112 of the one or more vehicle charging facilities 110 at the charging station 100. In some embodiments, the inductive charging transmitter 172 is part of the charging amenity 116 for charging batteries 62 that are not installed in a vehicle. In some embodiments, AC power is applied via the inductive charging transmitter 172 to the inductive charging receiver 176, and an AC-to-DC converter converts the AC power into DC power, which is applied to the battery 62. The inductive charging transmitter 172 and inductive charging receiver 176 may include one or more of an AC-to-DC convertor, a DC-to-DC converter, electrical and/or electro-mechanical components, any one or more of a variety of semiconductors, power semiconductors, integrated circuits, vibrators, transformers, inductors, magnetic field storage components, capacitors, field-effect transformers, transistors, and diodes, or other similar systems and components in any combination.

In some embodiments, the controller 150 is communicatively coupled to the inductive charging transmitter 172. For example, the controller 150 may be communicatively coupled to one or more sensors 174 of the inductive charging transmitter 172. In some embodiments, one of the one or more sensors 174 measures a parameter of the inductive charging transmitter 172 or of the battery 62, such as a voltage of the battery 62, a voltage or current at the inductive charging transmitter 172, or a temperature of the inductive charging transmitter 172. The controller 150 monitors and controls the functioning of the inductive charging transmitter 172.

In some embodiments, the controller 150 is communicatively coupled to the inductive charging receiver 176. In an example, the controller 150 is communicatively coupled to one or more sensors of the inductive charging receiver 176. In some embodiments, the one or more sensors 174 are installed in the inductive charging receiver 176 instead of in the inductive charging transmitter 172. In some embodiments, at least one sensor 174 is installed in the inductive charging receiver 176 and at least one sensor 174 is installed in the inductive charging transmitter 172. In some embodiments, the controller 150 monitors and controls the functioning of the inductive charging receiver 176.

In some embodiments, the controller 150 is communicatively coupled to the battery 62, as described above.

In FIG. 5, the thermal control module is represented by thermal control module 180B. Thermal control module 180B includes an electrical element 186. In some embodiments, the electrical element 186 is an electrically resistive heating element. In some embodiments, the electrical element 186 is a thermoelectric heat pump. In some embodiments, the thermoelectric heat pump provides heat to the battery 62. In some embodiments, the thermoelectric heat pump provides cooling to the battery 62 by operating according to the Peltier Effect.

In some embodiments, the controller 150 is communicatively coupled to the thermal control module 180B. In some embodiments, the controller 150 monitors and controls the functioning of the thermal control module 180B. In some embodiments, the controller 150 is communicatively coupled to the electrical element 186. In some embodiments, the controller 150 may be communicatively coupled to one or more sensors of the electrical element 186. In an example, the one or more sensors measure a parameter of the electrical element 186, such as a temperature, a voltage, or a current. In some embodiments, the controller 150 monitors and controls the functioning of the electrical element 186.

It is contemplated that the system 160A may include thermal control module 180B instead of thermal control module 180A. It is contemplated that the system 160A may include thermal control module 180A as well as thermal control module 180B. It is contemplated that thermal control module 180A and thermal control module 180B may be omitted from the system 160A.

It is contemplated that the system 160B may include thermal control module 180A instead of thermal control module 180B. It is contemplated that the system 160B may include thermal control module 180A as well as thermal control module 180B. It is contemplated that thermal control module 180A and thermal control module 180B may be omitted from the system 160B.

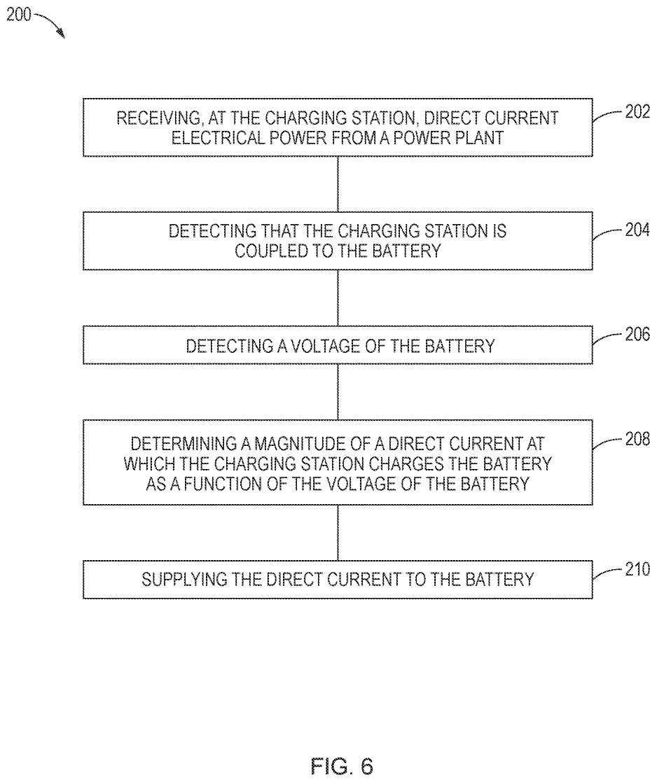

FIG. 6 is a flow diagram of a method 200 of charging a battery of an electric or hybrid vehicle at a charging station. In an example, the battery is a traction battery of the electric or hybrid vehicle, such as battery 62. In some embodiments, method 200 is conducted using the charging station 100. In some embodiments, method 200 is performed while the electric or hybrid vehicle is plugged into a charging point of one or more vehicle charging facilities at the charging station. In some embodiments, method 200 is performed while the battery is not installed in the electric or hybrid vehicle, but is coupled to the charging station, such as at the one or more charging amenities.

In some embodiments, method 200 is monitored by a controller, such as controller 150. In some embodiments, method 200 is controlled by a controller, such as controller 150. In some embodiments, various sensors are used in performing method 200. The sensors may include one or more voltmeters, ammeters, ohmmeters, or other such sensors, whether digital or analog. The sensors may be electrically coupled to the controller.

Operation 202 includes receiving, at the charging station, direct current electrical power from a power plant (such as power plant 120). In some embodiments, the power plant includes one or more renewable energy sources, such as solar, solar thermal, wind, or geothermal energy sources. In some embodiments, the power plant produces direct current electrical power, and the direct current electrical power is transmitted to the charging station via a local power distribution system, such as local power distribution system 130. In some embodiments, the local power distribution system is operated as a DC microgrid.

Operation 204 includes detecting that the charging station is coupled to the battery. In some embodiments, the charging station is coupled to the battery by a charging cable, such as charging cable 114. In some embodiments, the charging station is coupled to the battery by via a wired electrical connection. In an example, the wired electrical connection is provided by an adapter, such as adapter 164. In some embodiments, the charging station is coupled to the battery by via an inductive connection. In an example, the inductive connection is provided by an inductive charging transmitter (such as inductive charging transmitter 172) that interacts with an inductive charging receiver (such as inductive charging receiver 176).

Operation 206 includes detecting a voltage of the battery. In some embodiments, operation 204 incorporates operation 206. In some embodiments, operation 206 includes detecting a magnitude of the voltage of the battery, such as by measuring the voltage of the battery using a sensor (such as a voltmeter, sensor, sensor, or the like).

Operation 208 includes determining a magnitude of a direct current at which the charging station charges the battery. In some embodiments, the magnitude of the direct current is determined as a function of the voltage of the battery. In some embodiments, operation 208 includes accessing a predetermined correlation between the magnitude of the voltage of the battery and the magnitude of the direct current to be used when charging the battery. In some embodiments, operation 208 includes calculating the magnitude of the direct current to be used when charging the battery by using the magnitude voltage of the battery as an input.

Operation 210 includes supplying the direct current to the battery. In some embodiments, the controller may adjust the direct current at which the charging station charges the battery during the charging of the battery. In some embodiments, the controller may contemporaneously adjust the direct current at which the charging station charges the battery as a function of the voltage of the battery. For example, the controller may cause the supply the direct current initially at a first magnitude (such as when the voltage of the battery is at or less than fifty percent of the maximum capacity of the battery), and may decrease the direct current towards a second magnitude as the voltage of the battery increases towards the maximum. Such a technique may increase charging efficiency compared with supplying the direct current at a constant magnitude. Similarly, such a technique may provide a fuller charge to the battery, and increase the life span of the battery.

In some embodiments, method 200 includes detecting a temperature of the battery, and supplying heat to the battery. In some embodiments, supplying heat to the battery includes opening a valve of a fluid circuit to permit a fluid to flow through the fluid circuit proximal to the battery. In some embodiments, supplying heat to the battery includes energizing an electric heating element proximal to the battery.

In some embodiments, method 200 includes determining that the voltage of the battery is at least at a recharged magnitude. In an example, the recharged magnitude may be a magnitude of voltage at which the manufacturer of the battery recommends stopping the charging of the battery. In another example, the recharged magnitude may be a magnitude of voltage at which a user of the electric or hybrid vehicle chooses to stop charging the battery. In some embodiments, the electric or hybrid vehicle may include a battery disconnect unit that is actuated when the battery reaches a predetermined level of charge to prevent further charging of the battery.

In some embodiments, the recharged magnitude may be at least twenty percent of the maximum capacity of the battery, such as at least thirty percent, at least forty percent, at least fifty percent, at least sixty percent, at least seventy percent, at least eighty percent, at least ninety percent, or one hundred percent of maximum capacity.

In some embodiments, method 200 includes stopping the supplying of the direct current to the battery. In some embodiments, method 200 includes closing the valve to cease flowing the fluid through the fluid circuit. In some embodiments, method 200 includes switching off an electric heating element proximal to the battery.

It is contemplated that method 200 may include any one or more of the operations or activities described herein. It is contemplated that method 200 may be performed using at least some of the apparatus or systems described herein.

Aspects of the present disclosure include systems and methods for charging electric vehicles of any type. The systems and methods of the present disclosure may be established or performed in locations where there is no (or limited) existing electrical transportation infrastructure or capacity, such as in remote and/or rural areas.

In some aspects, a charging system includes a geothermal power generation plant configured to produce direct current electrical power, and a charging station electrically coupled to the geothermal power plant. The charging station is configured to receive the direct current electrical power and provide a direct current to a battery of an electric or hybrid vehicle.

A charging system incorporating DC electrical power generation (such as a solar, solar thermal, wind, or geothermal power plant), DC power transmission, and DC power utilization has reduced operational complexity compared with conventional systems based on AC electrical power.

It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

What is claimed is:

1. A system, comprising:
a geothermal power plant configured to produce direct current electrical power; and
a charging station electrically coupled to the geothermal power plant, and configured to receive the direct current electrical power and provide a direct current to a battery of an electric or hybrid vehicle.

2. The system of claim 1, further comprising a local power distribution system configured to convey the direct current electrical power from the geothermal power plant to the charging station.

3. The system of claim 2, wherein the local power distribution system is an autonomous power distribution system.

4. The system of claim 1, wherein at least a portion of the geothermal power plant is co-located with the charging station.

5. The system of claim 1, further comprising a direct current-to-direct current converter electrically coupled to the geothermal power plant and the charging station.

6. The system of claim 1, wherein the charging station includes at least one of:
an adapter configured to couple to a receptacle that is electrically coupled to the battery of the electric or hybrid vehicle; or
an inductive charging transmitter configured to wirelessly couple to an inductive charging receiver that is electrically coupled to the at least one battery of the electric or hybrid vehicle.

7. The system of claim 1, wherein the charging station includes a thermal control module configured to provide one of heat or cooling to the battery during charging of the battery.

8. The system of claim 7, wherein the thermal control module includes at least one of a fluid circuit, an electrically resistive heating element, or a thermoelectric heat pump.

9. A system, comprising:
a power plant configured to produce direct current electrical power;
a charging station electrically coupled to the power plant, and configured to receive the direct current electrical power and provide a direct current to a battery of an electric or hybrid vehicle; and
a controller comprising instructions that, when executed, cause a plurality of operations to be conducted, the plurality of operations comprising:
detecting that the charging station is coupled to a battery of an electric or hybrid vehicle;
detecting a voltage of the battery;
determining a magnitude of the direct current at which the charging station charges the battery as a function of the voltage of the battery; and
supplying the direct current to the battery.

10. The system of claim 9, wherein the plurality of operations further comprise:
detecting a temperature of the battery; and
supplying heat to the battery.

11. The system of claim 10, wherein the plurality of operations further comprise opening a valve of a fluid circuit to permit a fluid to flow through the fluid circuit proximal to the battery.

12. The system of claim 11, wherein the plurality of operations further comprise:
determining that the voltage of the battery is at least at a recharged level; and
closing the valve to cease flowing the fluid through the fluid circuit.

13. The system of claim 9, wherein the plurality of operations further comprise:
determining that the voltage of the battery is at least at a recharged level; and
stopping the supplying of the direct current to the battery.

14. The system of claim 9, wherein the power plant includes at least one of a solar, solar thermal, wind-driven, or geothermal power plant.

15. The system of claim 9, wherein at least a portion of the power plant is co-located with the charging station.

16. A method of charging a battery of an electric or hybrid vehicle at a charging station, the method comprising:
receiving, at the charging station, direct current electrical power from a power plant;
detecting that the charging station is coupled to the battery;
detecting a voltage of the battery;
determining a magnitude of a direct current at which the charging station charges the battery as a function of the voltage of the battery; and
supplying the direct current to the battery.

17. The method of claim 16, further comprising:
detecting a temperature of the battery; and
supplying heat to the battery.

18. The method of claim 17, further comprising opening a valve of a fluid circuit to permit a fluid to flow through the fluid circuit proximal to the battery.

19. The method of claim 18, further comprising:
determining that the voltage of the battery is at least at a recharged level; and
closing the valve to cease flowing the fluid through the fluid circuit.

20. The method of claim 16, further comprising:
determining that the voltage of the battery is at least at a recharged level; and
stopping the supplying of the direct current to the battery.
